(19) United States
(12) Patent Application Publication
(10) Pub. No.: US 2025/0383130 A1
(43) Pub. Date: Dec. 18, 2025

(54) MULTILAYER COMPOSITE TUBE WITH STATIC DISCHARGE-RESISTANT LAYERS

(71) Applicant: Titeflex Corporation, Springfield, MA (US)

(72) Inventors: Brandon Carter, Lafayette, TN (US); Paul Beshear, Springfield, TN (US); Donald Bradley Campbell, Gallatin, TN (US); Jordan Strunk, Portland, TN (US)

(73) Assignee: Titeflex Corporation, Springfield, MA (US)

(21) Appl. No.: 19/206,772

(22) Filed: May 13, 2025

Related U.S. Application Data
(60) Provisional application No. 63/660,797, filed on Jun. 17, 2024.

(51) Int. Cl. F25B 39/02; F16L 11/04; F25B 31/00

(52) U.S. Cl. CPC F25B 39/02; F16L 11/045; F25B 31/00

(57) ABSTRACT

An apparatus of a composite refrigeration line set that includes a suction line and return line characterized in that one or more of the suction line and the return line are a composite refrigeration line set tube. The set tube includes an inner plastic tube, a first adhesive layer external to the inner plastic tube, an aluminum layer circumferentially surrounding the first adhesive layer and coupled to the inner plastic tube via the first adhesive layer, a second adhesive layer external to the aluminum layer, and an outer plastic layer circumferentially surrounding the aluminum layer and coupled to the aluminum layer via the second adhesive layer. The inner plastic tube is a polyethylene of raised temperature and includes conductive additives. The outer plastic tube is polyethylene of raised temperature.

### CROSS-REFERENCE TO RELATED APPLICATION(S)

This application claims the benefit of priority to U.S. Provisional Patent Application Ser. No. 63/660,797, filed Jun. 17, 2024. The entire content of each application is hereby incorporated by reference herein.

### BACKGROUND OF THE INVENTION

Multilayer composite tubes are designed and used to convey liquids, primarily water, for applications such as in floor heating, radiator heating, and water supply.

### SUMMARY OF THE INVENTION

One or more aspects of the invention can be a refrigeration system that includes a compressor, an evaporator coil, and a composite refrigeration line set coupled between the compressor and the evaporator coil to form a fluid circuit between the compressor and the evaporator coil. The composite refrigeration line set can include a suction line and a return line, and characterized in that one or more of the suction line and the return line are a composite refrigeration line set tube. The composite refrigeration line set tube can include an inner plastic tube, a first adhesive layer external to the inner plastic tube, an aluminum layer circumferentially surrounding the first adhesive layer and coupled to the inner plastic tube via the first adhesive layer, a second adhesive layer external to the aluminum layer, and an outer plastic layer circumferentially surrounding the aluminum layer and coupled to the aluminum layer via the second adhesive layer. The inner plastic tube can be a polyethylene of raised temperature and includes conductive additives such that the inner plastic tube has a surface conductivity ranging between 10² ohms/in² and 10¹² ohms/in² (10⁷ ohms/m² and 10¹⁷ ohms/m²). The outer plastic tube can be polyethylene of raised temperature.

One or more aspects of the invention can be a refrigeration system that includes a compressor, an evaporator coil, and a composite refrigeration line set coupled between the compressor and the evaporator coil to form a fluid circuit between the compressor and the evaporator coil. The composite refrigeration line set can include a suction line and a return line, and characterized in that one or more of the suction line and the return line are a composite refrigeration line set tube. The composite refrigeration line set tube can include an inner plastic tube, a first adhesive layer external to the inner plastic tube, an aluminum layer circumferentially surrounding the first adhesive layer and coupled to the inner plastic tube via the first adhesive layer, a second adhesive layer external to the aluminum layer, and an outer plastic layer circumferentially surrounding the aluminum layer and coupled to the aluminum layer via the second adhesive layer. The inner plastic tube can be a polyethylene of raised temperature and includes conductive additives such that the inner plastic tube has a surface conductivity ranging between 10² ohms/in² and 10¹² ohms/in² (10⁷ ohms/m² and 10¹⁷ ohms/m²). The first adhesive layer can be a hot-melt adhesive. The second adhesive layer can be a hot-melt adhesive. The outer plastic tube can be polyethylene of raised temperature.

One or more aspects of the invention can be a refrigeration system that includes a compressor, an evaporator coil, and a composite refrigeration line set coupled between the compressor and the evaporator coil to form a fluid circuit between the compressor and the evaporator coil. The composite refrigeration line set can include a suction line and a return line, characterized in that one or more of the suction line and the return line are a composite refrigeration line set tube. The composite refrigeration line set tube can include an inner plastic tube, an intermediate plastic tube circumferentially surrounding the inner plastic tube and coupled to the inner plastic tube, a first adhesive layer external to the intermediate plastic tube, an aluminum layer circumferentially surrounding the first adhesive layer and coupled to the intermediate plastic tube via the first adhesive layer, a second adhesive layer external to the aluminum layer, and an outer plastic layer circumferentially surrounding the aluminum layer and coupled to the aluminum layer via the second adhesive layer. The inner plastic tube can be a polyethylene of raised temperature and includes conductive additives such that the inner plastic tube has a surface conductivity ranging between 10² ohms/in² and 10¹² ohms/in² (10⁷ ohms/m² and 10¹⁷ ohms/m²). The intermediate plastic tube can be a polyethylene of raised temperature and is not conductive. The first adhesive layer can be a hot-melt adhesive. The second adhesive layer can be a hot-melt adhesive. The outer plastic tube can be polyethylene of raised temperature.

One or more aspects of the invention can be a refrigeration system that includes a compressor, an evaporator coil, and a composite refrigeration line set coupled between the compressor and the evaporator coil to form a fluid circuit between the compressor and the evaporator coil. The composite refrigeration line set can include a suction line and a return line, characterized in that one or more of the suction line and the return line are a composite refrigeration line set tube. The composite refrigeration line set tube can include an inner plastic tube, an aluminum layer circumferentially surrounding the inner plastic tube and coupled to the inner plastic tube, a fiber reinforcement layer circumferentially surrounding the aluminum layer, a polymer barrier circumferentially surrounding the fiber reinforcement layer, and an adhesive layer external to the polymer barrier. The inner plastic tube can be a liquid crystal polymer alloy and includes conductive additives such that the inner plastic tube has a surface conductivity ranging between 10² ohms/in² and 10¹² ohms/in² (10⁷ ohms/m² and 10¹⁷ ohms/m²). The adhesive layer can be an ultraviolet and infrared resistant polymer coating.

One or more aspects of the invention can be a refrigeration system that includes a compressor, an evaporator coil, and a composite refrigeration line set coupled between the compressor and the evaporator coil to form a fluid circuit between the compressor and the evaporator coil. The composite refrigeration line set can include a suction line and a return line, and characterized in that one or more of the suction line and the return line are a composite refrigeration line set tube. The composite refrigeration line set tube can include an inner plastic tube, an intermediate plastic tube circumferentially surrounding the inner plastic tube, an aluminum layer circumferentially surrounding the intermediate plastic tube and coupled to the intermediate plastic tube, a fiber reinforcement layer circumferentially surrounding the aluminum layer, a polymer barrier circumferentially surrounding the fiber reinforcement layer, and an adhesive layer external to the polymer barrier. The inner plastic tube can be a liquid crystal polymer alloy and includes conductive additives such that the inner plastic tube has a surface conductivity ranging between 10² ohms/in² and 10¹² ohms/in² (10⁷ ohms/m² and 10¹⁷ ohms/m²). The intermediate plastic tube can be a liquid crystal polymer alloy. The adhesive layer can be an ultraviolet and infrared resistant polymer coating,

One or more aspects of the invention can be a composite refrigeration line set that includes a suction line and a return line that is characterized in that one or more of the suction line and the return line are a composite refrigeration line set tube. The composite refrigeration line set tube can include an inner plastic tube, a first adhesive layer external to the inner plastic tub, an aluminum layer circumferentially surrounding the first adhesive layer and coupled to the inner plastic tube via the first adhesive layer, a second adhesive layer external to the aluminum layer, and an outer plastic layer circumferentially surrounding the aluminum layer and coupled to the aluminum layer via the second adhesive layer. The inner plastic tube can be a polyethylene of raised temperature and includes conductive additives such that the inner plastic tube has a surface conductivity ranging between 10² ohms/in² and 10¹² ohms/in² (10⁷ ohms/m² and 10¹⁷ ohms/m²). The outer plastic tube can be polyethylene of raised temperature.

These aspects of the invention can have a variety of embodiments. The refrigeration system can be a heat pump.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIGS. 1-3 are illustrative representations of a static dissipative multilayer composite tube, according to one or more embodiments of the invention.

FIG. 4 is an illustrative representation of an air conditioning system that implements a static dissipative multilayer composite tube, according to one or more embodiments of the invention.

FIG. 5 is a flow diagram of a workflow process for fabricating a static dissipative composite tube, according to one or more embodiments of the invention.

### DEFINITIONS

The instant invention is most clearly understood with reference to the following definitions:

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used herein, the term “alloy” refers to a homogenous mixture or metallic solid solution composed of two or more elements. Examples of alloys include austenitic nickel-chromium-based super-alloys (available, e.g., under the INCONEL® trademark from Huntington Alloys Corporation of Huntington, West Virginia), brass, bronze, steel, low carbon steel, phosphor bronze, stainless steel, and the like.

As used in the specification and claims, the terms “comprises,” “comprising,” “containing,” “having,” and the like can have the meaning ascribed to them in U.S. patent law and can mean “includes,” “including,” and the like.

As used in the specification and claims, the term “fiberglass” refers to fiber-reinforced plastic using glass fiber. Generally speaking, “E-glass” is understood to refer to alumina-calcium-borosilicate glasses used as a general purpose reinforcement where strength and high electrical resistivity are desired, while “S-glass” is understood to refer to magnesium aluminosilicate glasses used for textile substrates or reinforcement in composite structural applications that require high strength, modulus, and durability under conditions of extreme temperature or corrosive environments.

Unless specifically stated or obvious from context, the term “or,” as used herein, is understood to be inclusive.

As used herein, the term “metal” refers to any chemical element that is a good conductor of electricity and/or heat, and alloys thereof. Examples of metals include, but are not limited to, aluminum, cadmium, niobium (also known as “columbium”), copper, gold, iron, nickel, platinum, silver, tantalum, tin, titanium, zinc, zirconium, and the like.

As used herein, the term “resin” refers to any synthetic or naturally occurring polymer.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### DETAILED DESCRIPTION OF THE INVENTION

Multilayer composite tubes with static dissipative layers are described herein.

In multilayer composite tubes, static charge can build up on the inner diameter of the multilayer composite tubes due to triboelectric effect of refrigerants (in liquid or gas form) sliding against a dielectric surface of the composite tube. Accordingly, there remains a need for a composite tube to reduce and dissipate static charge.

A layer of the composite tube can be a static dissipative layer that includes conductive polymer additives to reduce static charge and/or static buildup. In some cases, the conductive additives can include, for example, carbon black, carbon nanotubes, graphene, inherently dissipative polymers, etc.

In some embodiments, the multilayer composite tube described herein can be used for efficient installation of air conditioning and/or refrigeration systems. For example, the multilayer composite tube is flexible such that it easily adapts to any bend and corner. The multilayer composite tube is light such that it is practical and quick to handle, but also to be inserted into ducts or under walls. For instance, the multilayer composite tube can be a 50-m, ⅜″ nominal diameter roll and have a mass of only 6.5 Kgs. In some implementations, the multilayer composite tube can be used as an alternative to copper pipes. The multilayer composite tube can also be used with refrigerant gasses on the market (e.g., R32), can resist from −30° C. to peaks of 130° C. (110° C. continuous), and is usable for pressures up to 60 bar. The multilayer composite tube described herein can also resist atmospheric agents and weathering. For example, the multilayer composite tube can be resistant to UV rays and the sunlight aggression 3 times more than common polyethylene film while preserving both the multilayer composite tube and insulating coatings, which is crucial for optimal efficiency of the air conditioning system.

In some implementations, a layer of the multilayer composite tube can also be a flame protective layer. In some cases, the flame protective layer can be an extruded polymer layer loaded with flame retardants, glass fibers, nanoclays, nanofibers, and the like. The flame protective layer can form a complete or substantially complete layer of char when exposed to flame, thereby preventing the flame from penetrating other layers of the composite tube.

Multilayer composite tubes can be fabricated from multiple layers of material including various plastics, adhesives and, in some cases metal layers. Exemplary constructions include are summarized below.

TABLE 1
Exemplary Multilayer Composite Pipe Constructions

| Short Name | Components |
|---|---|
| PE/AL/PE | Polyethylene / Aluminum / Polyethylene |
| PEX/AL/PEX | Cross-linked Polyethylene / Aluminum / Cross-linked |
| | Polyethylene |
| PERT/AL/PERT | Polyethylene of raised temperature / Aluminum / |
| | Polyethylene of raised temperature |

A variety of multilayer composite tubes and applications for the same are described in U.S. Patent Application Publication No. 2020/0400251.

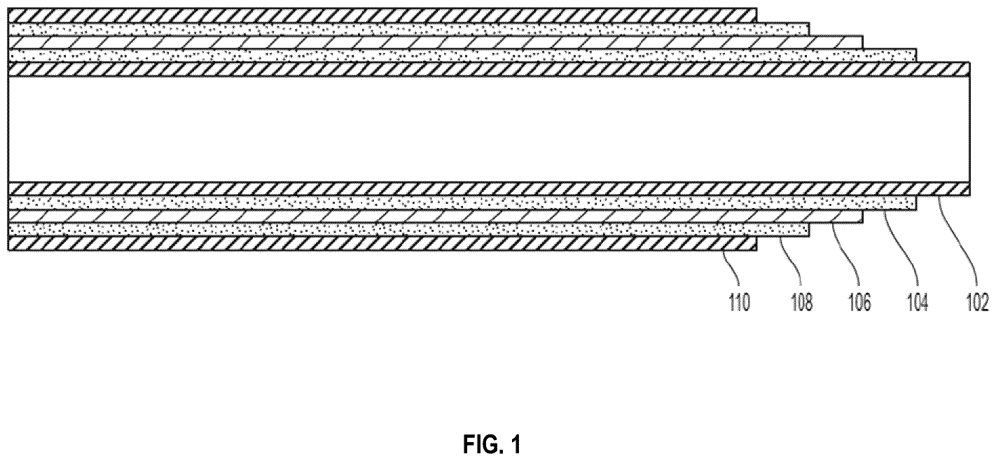

FIG. 1 is an illustrative representation of a static dissipative multilayer composite tube, according to one or more embodiments of the invention. In some embodiments, the multilayer composite tube can include an inner plastic layer 102, a first layer of adhesive 104, a gas (e.g., oxygen) barrier (e.g., a layer of aluminum) 106, a second layer of adhesive 108, and an outer plastic layer 110.

The inner plastic layer 102 can be selected from a variety of materials such as, for example, thermoplastics, thermoplastic elastomers, polyethylene, polyethylene, polypropylene, polyvinyl chloride (PVC), polyamide, fluoropolymers, polyvinylidene fluoride (PVDF), fluorinated ethylene propylene (FEP), perfluroalkoxy alkane (PFA), and the like. In some implementations, the inner plastic layer 102 can be a tube that includes polyethylene pipe material such as, for example, a polyethylene of raised temperature (PERT) and includes conductive additives (e.g., carbon black, carbon nanotubes, graphene, inherently dissipative polymers, etc.) such that the inner plastic layer 102 has a surface conductivity ranging between 10² ohms/in² and 10¹² ohms/in² (10⁷ ohms/m² and 10¹⁷ ohms/m²).

The first layer of adhesive 104 can be a hot-melt adhesive and can include conductive additives such that the first adhesive layer has a surface conductivity ranging between 10² ohms/in² and 10¹² ohms/in². In some cases, the first layer of adhesive 104 can include, for example, carbon black, carbon nanotubes, graphene, polyethylene terephthalate, polycarbonate, polyetherimide, polyamide, polyphenylene sulfide, etc., In some implementations, the first layer of adhesive 104 can be external to the inner plastic layer 102.

The gas barrier 106 can be a metallic composition. For example, the gas barrier 106 can be aluminum, steel, copper, and the like. Aluminum may include beneficial properties for the gas barrier 106, such as reduced weight, anti-corrosiveness, manufacturing cost, and the like. In some implementations, the aluminum can have, for example, 0.1% or greater magnesium by mass. The aluminum can also be for example, AL 3004, AL 3005, AL 3105, AL 5052, AL 6061, and/or AL 8006. In some implementations, the gas barrier 106 can be circumferentially surrounding the first layer of adhesive 104.

The second layer of adhesive 108 can be a hot-melt adhesive and includes conductive additives. In some implementations, the second layer of adhesive 108 can have a surface conductivity ranging between 10² ohms/in² and 10¹² ohms/in² (10⁷ ohms/m² and 10¹⁷ ohms/m²). In some implementations, the second layer of adhesive 108 can be external to gas barrier 106. In some cases, the second layer of adhesive 108 can include, for example, carbon black, carbon nanotubes, graphene, polyethylene terephthalate, polycarbonate, polyetherimide, polyamide, polyphenylene sulfide, etc. In some implementations, the second layer of adhesive 108 can be external to the gas barrier 106.

The outer plastic layer 110 can include a tube of polyethylene pipe material such as, for example, PERT or other polymers such as, for example, carbon black, carbon nanotubes, graphene, and/or other inherently dissipative polymers. In some implementations, the outer plastic layer 110 can be circumferentially surrounding the second layer of adhesive 108. The composition of the multilayer composite tube can enable the potential voltage of the gas barrier 106 to be the same as the potential voltage of the inner plastic layer 102.

Alternatively or additionally, the outer plastic layer 110 can be or include, for example, flame resistant material within the layer's composition. For example, the outer plastic layer 110 can include flame retardants (e.g., magnesium hydroxide, aluminum trihydrate, and/or halogenated fire retardants), glass fibers, nanoclays, nanofibers, and the like. Further, the outer plastic layer 110 can also include a plastic component, similar to the inner plastic layer 102 discussed above. For example, the plastic component can include one or a combination of thermoplastics, thermoplastic elastomers, polyethylene, polyethylene, polypropylene, PVC, polyamide, fluoropolymers, PVDF, FEP, PFA, and the like. For example, the outer plastic layer 110 can be solution or suspension in which a polymer is the dispersion medium and the flame retardant is dissolved or dispersed within the polymer or adhered to the polymer.

The flame protective material of the outer plastic layer 110 can be highly loaded. For example, the filler loading for the flame protective material can be 50-90% by weight of the layer 110. In some cases, the specific gravity for the flame protective material can be greater than 1.5. In some cases, thermal foaming agents can also be a component of the layer 110, which can increase the char volume of the outer plastic layer 110 when exposed to flame.

In some cases, the composite tube can undergo extrusion procedures for formation. For example, the outer plastic layer 110 can be extruded to form the shape necessary for the tube. In some cases, the conductive and/or flame-protective materials and the plastic components of the outer plastic layer 110 can be extruded together, thereby forming the outer plastic layer 110. In some cases, the outer plastic layer 110 can undergo tandem extrusion or co-extrusion with other layers of the composite tube. For example, the outer plastic layer 110 can be co-extruded with the second layer of adhesive 108, which can bond the outer plastic layer 110 and the second layer of adhesive 108. This can facilitate a reduction in thickness of the outer plastic layer 110 required to adequately form a char layer in case of exposure to flame.

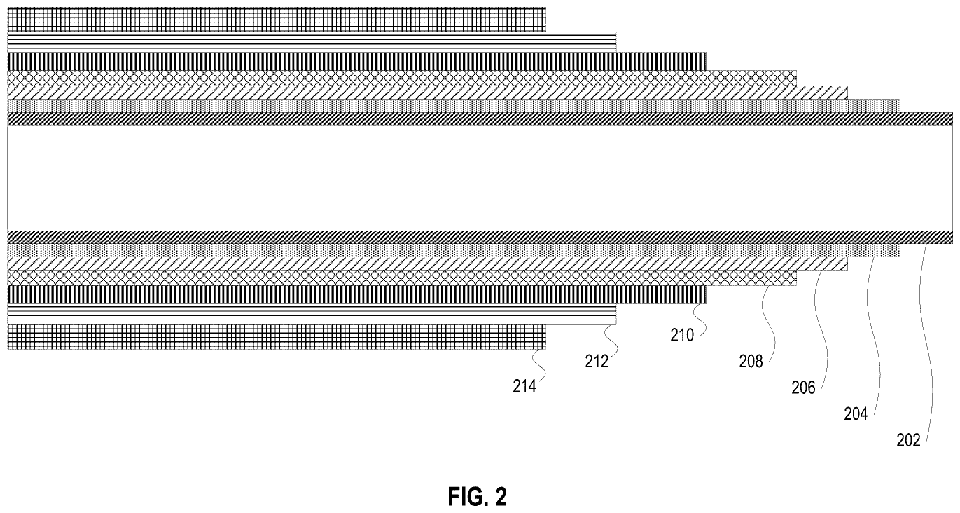

FIG. 2 is another illustrative representation of a static dissipative multilayer composite tube, according to one or more embodiments of the invention. In some cases, an intermediate plastic layer can be located between the outer plastic layer 110 and the gas barrier 106 of FIG. 1. As shown in FIG. 2, the multilayer composite tube can include an inner plastic layer 202, a first adhesive layer 204, a gas barrier 206, a second adhesive layer 208, an intermediate plastic layer 210, a third adhesive layer 212, and an outer plastic layer 214. The outer plastic layer 214. The inner plastic layer 202 can be consistent with the inner plastic layer 102 of FIG. 1. The first adhesive layer 204 can be consistent with the first adhesive layer 104 of FIG. 1. The gas barrier 206 can be consistent with the gas barrier 106 of FIG. 1. The outer plastic layer 214 can be consistent with the outer plastic layer 110 of FIG. 1. The multilayer composite tube in FIG. 2 can also include the intermediate plastic layer 210, which can be made of materials similar to those which the inner plastic layer 102 of FIG. 1.

The intermediate plastic layer 210 can be located between the outer plastic layer 214 and the gas barrier 206. The intermediate plastic layer 210 can further reduce thickness and tensile requirements of the outer plastic layer 214. For example, the outer plastic layer 214 can reduce the number of plastic components within the outer plastic layer 214 due to the location of the intermediate plastic layer 210.

In some implementations, the intermediate plastic layer 210 and outer plastic layer 214 can be co-extruded such that the intermediate plastic layer 210 provides tensile strength and elasticity (e.g., with regard to bending) while the outer plastic layer 214 is bonded to/coupled to and protects the intermediate plastic layer 214. For instance, even if the outer plastic layer 214 cracks (e.g., at a bend) the exposed intermediate plastic layer can be relatively small and foaming and charring of the outer plastic layer 214 can shield and/or limit combustion of the intermediate plastic layer 210 and/or reduce static charge of the intermediate plastic layer 210. For example, electrical continuity can be maintained through the inside of a bend, even if a conductive outer plastic layer 214 is stretched and/or disrupted along the outside of the bend.

In some embodiments, the intermediate plastic layer 210 can be a tube that is placed between the first plastic layer 202 and the first layer of adhesive 204, in which the intermediate plastic layer 210 is not conductive while the inner plastic layer 202 includes conductivity modified PERT or other polymer (e.g., carbon black, carbon nanotubes, graphene, inherently dissipative polymers, etc.) with surface conductivity ranging between 10² ohms/in² and 10¹² ohms/in² (10⁷ ohms/m² and 10¹⁷ ohms/m²). In such a configuration, the intermediate plastic layer 210 is circumferentially surrounding the inner plastic layer 202 and coupled to the inner plastic layer 202 while the first layer of adhesive 204 is external to the intermediate plastic layer 210.

Embodiments of the invention can include multiple conductive and/or flame-retardant layers, either adjacent or separate from each other. For example, a flame retardant layer can be included between the first plastic layer 102 and the first layer of adhesive 104, between the first layer of adhesive 104 and the gas barrier 106, between the first plastic layer 202 and the first layer of adhesive 204, between the first layer of adhesive 204 and the gas barrier 206, and/or the like. In some cases, flame protective material can also be included in the first plastic layers 102 and 202.

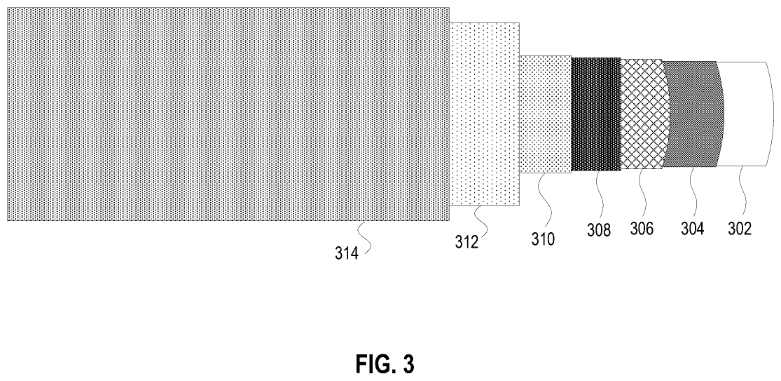

FIG. 3 is another illustrative representation of a static dissipative multilayer composite tube, according to one or more embodiments of the invention. The multilayer composite tube can include an inner plastic layer 302, an aluminum layer 304 circumferentially surrounding the inner plastic layer 302, a fiber layer 306 circumferentially surround the aluminum layer 304, a polymer barrier 308 circumferentially surrounding the fiber layer 306, and/or an adhesive layer 310 external to the polymer barrier 308. In some implementations, the adhesive layer 310 can be circumferentially surrounded by an insulation coating 312 and the insulation coating 312 can be circumferentially surrounded by an outer protective coating 314. The inner plastic layer 302 can be consistent with the inner plastic layers 102/202 of FIGS. 1 and 2, respectively. The aluminum layer 304 can be consistent with the gas barriers 106/206 of FIGS. 1 and 2, respectively.

In some embodiments, the inner plastic layer 302 can be, for example, a liquid crystal polymer alloy (LCPA) and can include conductive additives such that the inner plastic layer 302 has a surface conductivity ranging between 10² ohms/in² and 10¹² ohms/in² (10⁷ ohms/m² and 10¹⁷ ohms/m²). The aluminum layer 304 can be or include a 4-layer aluminum film. The fiber layer 306 can include high-tenacity synthetic fiber (e.g., aramids). The adhesive layer 310 can be or include anti-ultraviolet (UV) and anti-infrared (IR) coating. The insulation coating 302 can include a closed-cell polyethylene (PE) foam insulation coating. The outer protective coating 314 can include anti-ultraviolet (UV) and/or anti-infrared (IR) coating.

In some embodiments, the inner plastic layer 302 can be circumferentially surrounded by an intermediate plastic layer (not shown in FIG. 3) that includes LCPA and in which the aluminum layer 304 is external to the intermediate plastic layer and coupled to the intermediate plastic layer.

### Applications

The multilayer composite tube described herein can be used for a variety of applications.

For example, the multilayer composite tube can be used for common water conveyance applications. However, there are many other applications for which this type of tube can be used. These other applications could include the conveyance of other types of liquids and gases such as refrigerants, natural gas, propane, and process and medical gases such as argon, helium, nitrogen, and the like.

In some applications, the multilayer composite tube described herein can be used for efficient installation of air conditioning and/or refrigeration systems. For example, the multilayer composite tube can be flexible such that it easily adapts to any bend and corner, the multilayer composite tube can be light such that it is practical and quick to handle, the multilayer composite tube can be durable, and/or the like. In some implementations, the multilayer composite tube can be used as an alternative to copper pipes in HVAC/R line sets. The multilayer composite tube can also be used with most common refrigerant gases and resist atmospheric agents and weathering.

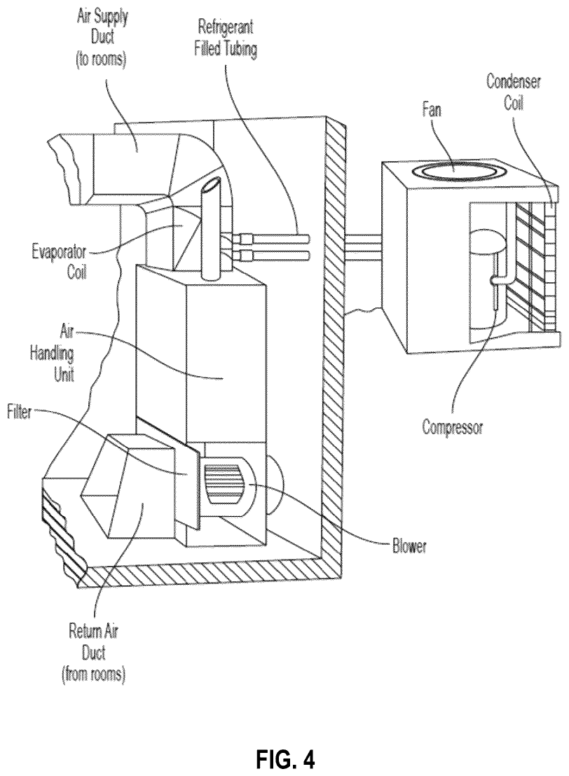

FIG. 4 is an illustrative representation of a refrigeration system such as, for example, an air conditioning system, that implements a static dissipative multilayer composite tube, according to one or more embodiments of the invention. The refrigeration system can be configured to act as a heat pump that extracts heat from air surrounding the condenser coil and transfers that heat to the evaporator coil to heat a structure. Notably, operation as a heat pump generates higher refrigerant temperatures that soften the inner plastic layer 102 and the outer plastic layer 110 and place increased tensile loads on gas barrier 106 of FIG. 1.

The refrigeration system can include a suction line and a return line. Either or both of the suction line and the return line can include the flame protective composite tubes described above. In one embodiment, multilayer composite tubes can be utilized as line sets for a refrigeration or air conditioning system carrying a flammable (e.g., slightly flammable or highly flammable) refrigerant.

Refrigerants are listed by the American Society of Heating, Refrigeration, and Air Conditioning Engineers (ASHRAE) in ASHRAE Standard 34 (2019). The ASHRAE 34 Standard Committee determines toxicity and flammability classification. Class A refrigerants have lower toxicity. Class B refrigerants have higher toxicity. Flammability classifications are summarized in Table 6-1 of ASHRAE Standard 34. Embodiments of the invention can be utilized with A1, A2L, A2, A3, B1, B2L, B2, or B3 refrigerants.

Many of such refrigerants have a low global warming potential (GWP), e.g., a GWP of 500 or lower.

Exemplary refrigerants are listed in Table 2 below.

TABLE 2
Exemplary Refrigerants

| | | |
|---|---|---|
| | | ASHRAE |
| IUPAC name | Structure | Designation |

Hydrocarbons and dimethylether

| | | |
|---|---|---|
| Ethane | CH₃—CH₃ | R-170 |
| Propene (propylene) | CH₂═CH—CH₃ | R-1270 |
| Propane | CH₃—CH₂—CH₃ | R-290 |
| Methoxymethane (dimethylether) | CH₃—O—CH₃ | R-E170 |
| Cyclopropane | —CH₂—CH₂—CH₂— | R-C270 |

Fluorinated alkanes (HFCs)

| | | |
|---|---|---|
| Fluoromethane | CH₃F | R-41 |
| Difluoromethane | CH₂F₂ | R-32 |
| Fluoroethane | CH₂F—CH₃ | R-161 |
| 1,1-Difluoroethane | CHF₂—CH₃ | R-152a |
| 1,1,2,2-Tetrafluoroethane | CHF₂—CHF₂ | R-134 |

Fluorinated alkenes (HFOs) and alkynes

| | | |
|---|---|---|
| Fluoroethene | CHF═CH₂ | R-1141 |
| 1,1,2-Trifluoroethene | CF₂═CHF | R-1123 |
| 3,3,3-Trifluoroprop-1-yne | CF₃—C≡CH | NA |
| 2,3,3,3-Tetrafluoroprop-1-ene | CH₂═CF—CF₃ | R-1234yf |
| (E)-1,2-difluoroethene | CHF═CHF | R-1132(E) |
| 3,3,3-Trifluoroprop-1-ene | CH₂═CH—CF₃ | R-1243zf |
| 1,2-Difluoroprop-1-ene^{§} | CHF═CF—CH₃ | R-1252ye^{§} |
| (E)-1,3,3,3-tetrafluoroprop-1-ene | CHF═CH—CF₃ | R-1234ze(E) |
| (Z)-1,2,3,3,3-pentafluoro-prop-1-ene | CHF═CF—CF₃ | R-1225ye(Z) |
| 1-Fluoroprop-1-ene^{§} | CHF═CH—CH₃ | R-1261ze^{§} |
| R32/R1234 | Blend | R-454B |

Fluorinated Oxygenates

| | | |
|---|---|---|
| Trifluoro(methoxy)methane | CF₃—O—CH₃ | R-E143a |
| 2,2,4,5-Tetrafluoro-1,3-dioxole | —O—CF₂—O—CF═CF— | NA |

Fluorinated Nitrogen and Sulfur Compounds

| | | |
|---|---|---|
| N,N,1,1-tetrafluormethaneamine | CHF₂—NF₂ | NA |
| Difluoromethanethiol | CHF₂—SH | NA |
| Trifluoromethanethiol | CF₃—SH | NA |

Inorganic Compounds

| | | |
|---|---|---|
| Carbon dioxide | CO₂ | R-744 |
| Ammonia | NH₃ | R-717 |

Current HFCs and HCFCs

| | | |
|---|---|---|
| Pentafluoroethane | CF₃—CHF₂ | R-125 |
| R-32/125 (50.0/50.0) | Blend | R-410A |
| Chlorodifluoromethane | CHClF₂ | R-22 |
| 1,1,1,2-Tetrafluoroethane | CF₃—CH₂F | R-134a |

Accordingly, embodiments of the invention can include both a system including one or more AC/refrigeration components (e.g., a compressor and/or an evaporator coil), a multilayer-composite-tube line set, and refrigerant (e.g., in the assembled system or in a container for charging the system after assembly) as well as a system including a multilayer-composite-tube line set and a container of refrigerant for charging an AC/refrigeration system after installation of the multilayer-composite-tube line set between the evaporator coil and the compressor.

The composite multi-layer tube can be configured to meet one or more applicable standards. For example, the composite multi-layer tube can be configured to have a flame and smoke spread rating of no more than 25/50 when tested in isolation (e.g., a pair consisting of a suction line and a return line as would be used in the field) using the ASTM E84-20 Standard Test Method for Surface Burning Characteristics of Building Materials and/or Appendix A1.22 of the CAN/ULC-S102-10 Standard Test Method for Surface Burning Characteristics of Building Materials and Assemblies. The composite multi-layer tube can be configured such that the aluminum layer remains intact after completion of one of these tests.

### Reinforcement Layers

Depending on the application of the use for the flame protective composite tube, greater performance standards may be required, making it necessary to further enhance the standard multilayer product design to ensure higher pressure and temperature limits. This enhancement can be accomplished by adding yet another layer of material to the overall construction, thereby creating a reinforcement layer. Additionally or alternatively, the reinforcement can be added within the one of the layers described above.

The reinforcement can be constructed in several forms. For example, the reinforcement can be spirally (e.g., helically) wrapped, longitudinal, braided, and the like under, over, or within any of the layers. For example, a reinforcement layer can be around or within the inner plastic layer 102, around or within the outer plastic layer 110, around the gas (e.g., oxygen) barrier (e.g., metal) 106, or around or within the first layer of adhesive layer 104 and the second layer of adhesive 108. The reinforcement layer can completely cover or partially cover the surface of each of the inner plastic layer 102, the first layer of adhesive 104, the gas barrier 106, the second layer of adhesive 108, and the outer plastic layer 110.

The reinforcement material can include one or more individual material spirals wrapped around the tube (e.g., one material spirally wound with axial pitch of 0.25″ or four spirals with individual pitch of 1″ or 0.25″ collectively). Tube capacity (e.g., in terms of burst strength) can be adjusted based on pitch, material selection, and the like. For example, the tubing can have a burst pressure in excess of 1,900 psi at 70° F. and 1,500 psi at 200° F.

The reinforcement can include one or more materials such as metal foils (e.g., aluminum or copper), plastic films, metal wire, plastic wire, fiberglass cords or fabric (e.g., AR-glass, C-glass, D-glass, E-glass, E-CR-glass, R-glass, S-glass, and the like), any type of filament material, aramids, para-aramids, poly-aramid synthetic fibers, aromatic polyester strands, and the like. The reinforcing materials can be coated (e.g., with a binder or primer), machined (e.g., roughened), etched, or otherwise treated to bond to or be embedded within the adhesive layers.

In some cases, the reinforcement can be coated with a flame retardant so that the reinforcement layer provides flame protection. In some embodiments, a particular adhesive layer (e.g., a tie resin, a solvent-based adhesive, a hot-melt adhesive, and the like) is utilized to bond particular reinforcements.

In some embodiments, the reinforcement is applied after the product is extruded (e.g., a spiral wrap applied with a wrapping machine). In other embodiments, a spiral wrap is formed with a rotating extrusion crosshead such that the spiral material is extruded within a layer of polymer or adhesive (e.g., wire inside polymer). In still another embodiment, a spiral wrap is formed with a rotating extrusion crosshead (e.g., polyester cord extruded in a helix around an underlying tube). In still another embodiment, a longitudinal wrap can be added to any layer of the tube.

### Method of Fabricating Flame Protective Composite Tube

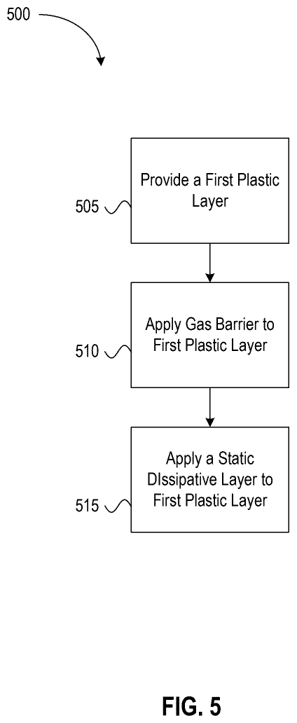

FIG. 5 is a flow diagram of a method 500 for fabricating a static-dissipative composite tube, according to one or more embodiments of the invention.

At 505 of the method 500, a first plastic layer can be provided. In some cases, the first plastic layer can be a resin layer formed via extrusion.

At 510 of the method 500, a gas barrier layer can be applied to the exterior of the first plastic layer. The gas barrier layer can be applied to the exterior of the first plastic layer by a variety of techniques. In some cases, the gas barrier layer can be a resin layer applied to the tubing by extrusion. The gas barrier layer can be, for example, a foil, laminated foil, tape or wire layer or the like and can be wound onto the tubing. A foil, laminated foil, tape or wire can be wrapped around the first plastic layer through a number of methods, including helically and radially wrapping.

At 515 of the method 500, a static dissipative layer can be applied to the exterior of the gas barrier layer and the first plastic layer. The static dissipative layer can be a layer of conductivity modified PERT or other polymer with surface conductivity that is applied to the first plastic layer by extrusion. In this case, the components of the static dissipative layer (e.g., plastic components and flame resistant materials) can be components of the conductivity modified PERT or other polymer.

In some cases, an adhesive (e.g., a conductive adhesive, a non-conductive adhesive, etc.) can be used to secure the gas barrier to the first plastic layer. Further, in some cases, an adhesive (e.g., a conductive or non-conductive adhesive) can be used to secure the flame protective layer to the gas barrier layer.

In some cases in which the first plastic layer and the static dissipative layer are both conductivity modified PERT or other polymer, 510 and 515 can be carried out simultaneously through co-extrusion.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. A refrigeration system comprising:
a compressor;
an evaporator coil; and
a composite refrigeration line set coupled between the compressor and the evaporator coil to form a fluid circuit between the compressor and the evaporator coil, the composite refrigeration line set comprising:
a suction line; and
a return line;
characterized in that one or more of the suction line and the return line are a composite refrigeration line set tube comprising:
an inner plastic tube;
a first adhesive layer external to the inner plastic tube;
an aluminum layer circumferentially surrounding the first adhesive layer and coupled to the inner plastic tube via the first adhesive layer;
a second adhesive layer external to the aluminum layer; and
an outer plastic layer circumferentially surrounding the aluminum layer and coupled to the aluminum layer via the second adhesive layer;
wherein:
the inner plastic tube is a polyethylene of raised temperature and includes conductive additives such that the inner plastic tube has a surface conductivity ranging between 10² ohms/in² and 10¹² ohms/in² (10⁷ ohms/m² and 10¹⁷ ohms/m²); and
the outer plastic tube is polyethylene of raised temperature.

2. The refrigeration system of claim 1, wherein the conductive additives of the inner plastic tube includes one or more selected from the group consisting of: carbon black, carbon nanotubes, graphene, polyethylene terephthalate, polycarbonate, polyetherimide, polyamide, and polyphenylene sulfide.

3. The refrigeration system of claim 1, wherein the conductive additives of the first adhesive layer includes one or more selected form the group consisting of: carbon black, carbon nanotubes, graphene, polyethylene terephthalate, polycarbonate, polyetherimide, polyamide, and polyphenylene sulfide.

4. The refrigeration system of claim 1, wherein the aluminum layer has one or more properties selected from the group consisting of:
being an alloy having 0.1% or greater magnesium by mass; and
being an alloy selected from the group consisting of: AL 3004, AL 3005, AL 3105, AL 5052, AL 6061, and AL 8006.

5. The refrigeration system of claim 1, wherein the outer plastic tube further includes at least one flame-resistant compound combined with the polyethylene of raised temperature, the at least one flame-resistant compound including one or more selected from the group consisting of: glass fibers nanoclay, nanofibers, a thermal foaming agent, and a combination thereof.

6. The refrigeration system of claim 1, wherein a potential voltage of the aluminum layer is the same as a potential voltage of the inner plastic tube.

7. The refrigeration system of claim 1, wherein the first adhesive layer is a hot-melt adhesive and includes conductive additives such that the first adhesive layer has a surface conductivity ranging between 10² ohms/in² and 10¹² ohms/in² (10⁷ ohms/m² and 10¹⁷ ohms/m²).

8. A refrigeration system comprising:
a compressor;
an evaporator coil; and
a composite refrigeration line set coupled between the compressor and the evaporator coil to form a fluid circuit between the compressor and the evaporator coil, the composite refrigeration line set comprising:
a suction line; and
a return line;
characterized in that one or more of the suction line and the return line are a composite refrigeration line set tube comprising:
an inner plastic tube;
a first adhesive layer external to the inner plastic tube;
an aluminum layer circumferentially surrounding the first adhesive layer and coupled to the inner plastic tube via the first adhesive layer;
a second adhesive layer external to the aluminum layer; and
an outer plastic layer circumferentially surrounding the aluminum layer and coupled to the aluminum layer via the second adhesive layer;
wherein:
the inner plastic tube is a polyethylene of raised temperature and includes conductive additives such that the inner plastic tube has a surface conductivity ranging between 10² ohms/in² and 10¹² ohms/in² (10⁷ ohms/m² and 10¹⁷ ohms/m²);
the first adhesive layer is a hot-melt adhesive;
the second adhesive layer is a hot-melt adhesive; and
the outer plastic tube is polyethylene of raised temperature.

9. The refrigeration system of claim 8, wherein the conductive additives of the inner plastic tube includes one or more selected from the group consisting of: carbon black, carbon nanotubes, graphene, polyethylene terephthalate, polycarbonate, polyetherimide, polyamide, and polyphenylene sulfide.

10. The refrigeration system of claim 8, wherein the aluminum layer has one or more properties selected from the group consisting of:
being an alloy having 0.1% or greater magnesium by mass; and
being an alloy selected from the group consisting of: AL 3004, AL 3005, AL 3105, AL 5052, AL 6061, and AL 8006.

11. The refrigeration system of claim 8, wherein the outer plastic tube further includes at least one flame-resistant compound combined with the polyethylene of raised temperature, the at least one flame-resistant compound including one or more selected from the group consisting of: glass fibers nanoclay, nanofibers, a thermal foaming agent, and a combination thereof.

12. The refrigeration system of claim 8, wherein a potential voltage of the aluminum layer is the same as a potential voltage of the inner plastic tube.

13. A refrigeration system comprising:
a compressor;
an evaporator coil; and
a composite refrigeration line set coupled between the compressor and the evaporator coil to form a fluid circuit between the compressor and the evaporator coil, the composite refrigeration line set comprising:
a suction line; and
a return line;
characterized in that one or more of the suction line and the return line are a composite refrigeration line set tube comprising:
an inner plastic tube;
an intermediate plastic tube circumferentially surrounding the inner plastic tube and coupled to the inner plastic tube;
a first adhesive layer external to the intermediate plastic tube;
an aluminum layer circumferentially surrounding the first adhesive layer and coupled to the intermediate plastic tube via the first adhesive layer;
a second adhesive layer external to the aluminum layer; and
an outer plastic layer circumferentially surrounding the aluminum layer and coupled to the aluminum layer via the second adhesive layer;
wherein:
the inner plastic tube is a polyethylene of raised temperature and includes conductive additives such that the inner plastic tube has a surface conductivity ranging between 10² ohms/in² and 10¹² ohms/in² (10⁷ ohms/m² and 10¹⁷ ohms/m²);
the intermediate plastic tube is a polyethylene of raised temperature and is not conductive;
the first adhesive layer is a hot-melt adhesive;
the second adhesive layer is a hot-melt adhesive; and
the outer plastic tube is polyethylene of raised temperature.

14. The refrigeration system of claim 13, wherein the conductive additives of the inner plastic tube includes one or more selected from the group consisting of: carbon black, carbon nanotubes, graphene, polyethylene terephthalate, polycarbonate, polyetherimide, polyamide, and polyphenylene sulfide.

15. The refrigeration system of claim 13, wherein the aluminum layer has one or more properties selected from the group consisting of:
being an alloy having 0.1% or greater magnesium by mass; and
being an alloy selected from the group consisting of: AL 3004, AL 3005, AL 3105, AL 5052, AL 6061, and AL 8006.

16. The refrigeration system of claim 13, wherein the outer plastic tube further includes at least one flame-resistant compound combined with the polyethylene of raised temperature, the at least one flame-resistant compound including one or more selected from the group consisting of:
glass fibers nanoclay, nanofibers, a thermal foaming agent, and a combination thereof.

17. The refrigeration system of claim 13, wherein a potential voltage of the aluminum layer is the same as a potential voltage of the inner plastic tube.

18. A refrigeration system comprising:
a compressor;
an evaporator coil; and
a composite refrigeration line set coupled between the compressor and the evaporator coil to form a fluid circuit between the compressor and the evaporator coil, the composite refrigeration line set comprising:
a suction line; and
a return line;
characterized in that one or more of the suction line and the return line are a composite refrigeration line set tube comprising:
an inner plastic tube;
an aluminum layer circumferentially surrounding the inner plastic tube and coupled to the inner plastic tube;
a fiber reinforcement layer circumferentially surrounding the aluminum layer;
a polymer barrier circumferentially surrounding the fiber reinforcement layer; and
an adhesive layer external to the polymer barrier;
wherein:
the inner plastic tube is a liquid crystal polymer alloy and includes conductive additives such that the inner plastic tube has a surface conductivity ranging between 10² ohms/in² and 10¹² ohms/in² (10⁷ ohms/m² and 10¹⁷ ohms/m²); and
the adhesive layer is an ultraviolet and infrared resistant polymer coating.

19. The refrigeration system of claim 18, wherein the conductive additives of the inner plastic tube includes one or more selected from the group consisting of: carbon black, carbon nanotubes, graphene, polyethylene terephthalate, polycarbonate, polyetherimide, polyamide, and polyphenylene sulfide.

20. The refrigeration system of claim 18, wherein the aluminum layer has one or more properties selected from the group consisting of:
being an alloy having 0.1% or greater magnesium by mass; and
being an alloy selected from the group consisting of: AL 3004, AL 3005, AL 3105, AL 5052, AL 6061, and AL 8006.

21. The refrigeration system of claim 18, wherein a potential voltage of the aluminum layer is the same as a potential voltage of the inner plastic tube.

22. A refrigeration system comprising:
a compressor;
an evaporator coil; and
a composite refrigeration line set coupled between the compressor and the evaporator coil to form a fluid circuit between the compressor and the evaporator coil, the composite refrigeration line set comprising:
a suction line; and
a return line;
characterized in that one or more of the suction line and the return line are a composite refrigeration line set tube comprising:
an inner plastic tube;
an intermediate plastic tube circumferentially surrounding the inner plastic tube;
an aluminum layer circumferentially surrounding the intermediate plastic tube and coupled to the intermediate plastic tube;
a fiber reinforcement layer circumferentially surrounding the aluminum layer;
a polymer barrier circumferentially surrounding the fiber reinforcement layer; and
an adhesive layer external to the polymer barrier;
wherein:
the inner plastic tube is a liquid crystal polymer alloy and includes conductive additives such that the inner plastic tube has a surface conductivity ranging between 10² ohms/in² and 10¹² ohms/in² (10⁷ ohms/m² and 10¹⁷ ohms/m²);
the intermediate plastic tube is a liquid crystal polymer alloy; and
the adhesive layer is an ultraviolet and infrared resistant polymer coating.

23. The refrigeration system of claim 22, wherein the conductive additives of the inner plastic tube includes one or more selected from the group consisting of: carbon black, carbon nanotubes, graphene, polyethylene terephthalate, polycarbonate, polyetherimide, polyamide, and polyphenylene sulfide.

24. The refrigeration system of claim 22, wherein the aluminum layer has one or more properties selected from the group consisting of:
being an alloy having 0.1% or greater magnesium by mass; and
being an alloy selected from the group consisting of: AL 3004, AL 3005, AL 3105, AL 5052, AL 6061, and AL 8006.

25. The refrigeration system of claim 22, wherein a potential voltage of the aluminum layer is the same as a potential voltage of the inner plastic tube.

26. An apparatus comprising a composite refrigeration line set, the composite refrigeration line set comprising:
a suction line; and
a return line that is characterized in that one or more of the suction line and the return line are a composite refrigeration line set tube comprising:
an inner plastic tube;
a first adhesive layer external to the inner plastic tube;
an aluminum layer circumferentially surrounding the first adhesive layer and coupled to the inner plastic tube via the first adhesive layer;
a second adhesive layer external to the aluminum layer; and
an outer plastic layer circumferentially surrounding the aluminum layer and coupled to the aluminum layer via the second adhesive layer;
wherein:
the inner plastic tube is a polyethylene of raised temperature and includes conductive additives such that the inner plastic tube has a surface conductivity ranging between 10² ohms/in² and 10¹² ohms/in² (10⁷ ohms/m² and 10¹⁷ ohms/m²); and
the outer plastic tube is polyethylene of raised temperature.

27. The apparatus of claim 26, wherein the first adhesive layer is a hot-melt adhesive and includes conductive additives such that the first adhesive layer has a surface conductivity ranging between 10² ohms/in² and 10¹² ohms/in².
